(19) United States
(12) Patent Application Publication
(10) Pub. No.: US 2024/0179700 A1
(43) Pub. Date: May 30, 2024

(54) RESOURCE DETERMINATION FOR TB OVER MULTIPLE SLOTS

(71) Applicant: Telefonaktiebolaget LM Ericsson (publ), Stockholm (SE)

(72) Inventors: Ling Su, Beijing (CN); Zhipeng Lin, Nanjing (CN); Robert Mark Harrison, Grapevine, TX (US)

(21) Appl. No.: 18/281,803

(22) PCT Filed: Mar. 25, 2022
(86) PCT No.: PCT/IB2022/052735

§ 371 Date: Sep. 13, 2023

(30) Foreign Application Priority Data
Mar. 25, 2021 (WO) PCT/CN2021/082996

(51) Int. Cl. H04W 72/1268; H04L 1/08; H04W 72/0446

(52) U.S. Cl. CPC H04W 72/1268; H04L 1/08; H04W 72/0446

(57) ABSTRACT

Systems and methods are disclosed herein for multiple slot Transport Block (TB) transmission with configured grant. In one embodiment, a method performed by a wireless communication device (WCD) comprises receiving, from a base station, information that configures one or more parameters for an uplink configured grant, determining physical uplink shared channel (PUSCH) resources for transmission of a multiple slot TB using the uplink configured grant, based on the one or more parameters, and transmitting the multiple slot TB on the determined PUSCH resources.

### RELATED APPLICATIONS

This application claims the benefit of international patent application serial number PCT/CN2021/082996, filed Mar. 25, 2021, the disclosure of which is hereby incorporated herein by reference in its entirety.

### TECHNICAL FIELD

The present disclosure relates to transmission of a multiple slot transport block in a wireless network.

### BACKGROUND

### Multi-Slot TB Transmission in NR Rel-17

In Third Generation Partnership Project (3GPP) New Radio (NR) Release15/16, one uplink (UL) Transport Block (TB) is confined to the UL symbols in a slot. To support high data rate, multiple Physical Resource Blocks (PRBs) in a slot can be used for the transmission of a large TB, and the multiple PRBs share UE transmission power. TB processing over multiple slots was proposed as a candidate solution for coverage enhancement of Physical Uplink Shared Channel (PUSCH) in NR Release 17. Multi-slot TB extends the time domain resource for the transmission of a TB across the slot border to: (a) increase total power for transmission of a TB compared to TB transmission in a single slot and (b) reduce Cyclic Redundancy Check (CRC) overhead in the slots except the last slot of the TB compared to the PUSCH repetition technique in time domain.

### SUMMARY

Systems and methods are disclosed herein for multiple slot or multi-slot Transport Block (TB) transmission with configured grant. In one embodiment, a method performed by a wireless communication device (WCD) comprises receiving, from a base station, information that configures one or more parameters for an uplink configured grant, determining physical uplink shared channel (PUSCH) resources for transmission of a multiple slot TB using the uplink configured grant, based on the one or more parameters, and transmitting the multiple slot TB on the determined PUSCH resources. In this manner, robust PUSCH transmission via a TB over multiple slots is provided in a manner that can improve resource utilization efficiency.

In one embodiment, a maximum number of repetitions for the multiple slot TB is preconfigured or predefined. In one embodiment, the maximum number of repetitions for the multi-slot TB depends on a number of slots used for the multi-slot TB. In one embodiment, a single maximum value of N*K is predetermined, wherein K is a number of repetitions of the multiple slot TB and N is a number of slots N for a repetition of the multiple slot TB.

In one embodiment, a redundancy version (RV) granularity for the multiple slot TB is: (a) all slots of the multiple slot TB. (b) a subset of all slots of the multiple slot TB, or (c) a single slot of the multiple slot TB. In another embodiment, transmitting the multiple slot TB comprises transmitting a number. K. of repetitions of the multiple slot TB, and a RV granularity for the multiple slot TB is all slots of a repetition of the multiple slot TB. In another embodiment, transmitting the multiple slot TB comprises transmitting a number, K, of repetitions of the multiple slot TB, and a RV granularity for the multiple slot TB is: (a) a subset of all slots of a repetition of the multiple slot TB or (b) a single slot of a repetition of the multiple slot TB. In one embodiment, a predetermined or indicated RV applies to a first transmission occasion of the multiple slot TB or a first transmission occasion of a first repetition of the multiple slot TB. In one embodiment, the RV is cycled across transmission occasions according to a predefined or configured RV cycling pattern.

In one embodiment, the method further comprises determining that at least one slot of the multiple slot TB is unavailable and, responsive to determining that at least one slot of the multiple slot TB is unavailable, dropping transmission of only the unavailable slot of the multiple slot TB. In another embodiment, the method further comprises determining that at least one slot of the multiple slot TB is unavailable and, responsive to determining that at least one slot of the multiple slot TB is unavailable, either: dropping transmission of all slots of the multiple slot TB, dropping transmission of the unavailable slot and all remaining slots of the multiple slot TB, or dropping transmission of a subset of all slots of the multiple slot TB, where the subset corresponds to a transmission occasion that comprises the unavailable slot.

In one embodiment, transmitting the multiple slot TB comprises transmitting a number, K. of repetitions of the multiple slot TB, and the method further comprises determining that at least one slot of a repetition of the multiple slot TB is unavailable and, responsive thereto, dropping transmission of only the unavailable slot in the repetition of the multiple slot TB. In one embodiment, transmitting the multiple slot TB comprises transmitting a number, K. of repetitions of the multiple slot TB, and the method further comprises determining that at least one slot of a repetition of the multiple slot TB is unavailable and, responsive thereto, dropping transmission of all slots in the repetition of the multiple slot TB or dropping transmission of the unavailable slot and all remaining slots in the repetition of the multiple slot TB.

In one embodiment, the WCD is not expected to have an unavailable slot for transmission of a first repetition of the multiple slot TB.

In one embodiment, determining the PUSCH resources for transmission of the multiple slot TB comprises determining a starting symbol, S, within a slot of the multiple slot TB. In one embodiment, the starting symbol, S, is a common starting symbol, S, value for at least a subset of (e.g., all of) the slots of the multiple slot TB. In one embodiment, the starting symbol, S, is a starting symbol, S, for a first slot from among the slots of the multiple slot TB. In one embodiment, the starting symbol, S, is a starting symbol, S, for a particular slot from among the slots of the multiple slot TB determined by the WCD based on signaling from the base station or predefined rule. In one embodiment, the starting symbol, S, is a starting symbol, S, for a particular slot from among the slots of the multiple slot TB that is selected for Hybrid Automatic Repeat Request (HARQ) identity determination.

In one embodiment, a duration of the multi-slot TB or a duration of all repetitions of the multi-slot TB is less than a time duration that corresponds to a periodicity of the uplink configured grant. In another embodiment, the multi-slot TB or repetitions of the multi-slot TB do not cross a boundary between two periods of the uplink configured grant.

In one embodiment, a value of a configured grant timer associated to the uplink configured grant is a multiple of a duration of the multi-slot TB.

In one embodiment, the WCD is configured with K repetitions for the multiple slot TB with the uplink configured grant, and: (i) the WCD is not expected to be configured with a time duration for transmission of the K repetitions of the multiple slot TB that is greater than a time duration of a periodicity of the uplink configured grant; and/or (ii) the time duration for the transmission of the K repetitions of the multiple slot TB is greater than the periodicity of the uplink configured grant, remaining resources within the time duration of the periodicity of the uplink configured grant after transmitting repetition X of the multiple slot TB, where X<K, is not sufficient to transmit a repetition of the multiple slot TB, and the WCD either: (I) does not transmit the remaining repetition(s) of the multiple slot TB or (II) transmits the remaining repetition(s) of the multiple slot TB until reaching an end of the time duration of the periodicity of the uplink configured grant.

In one embodiment, the WCD is configured with K repetitions for the multiple slot TB with the uplink configured grant, at least one symbol of at least one repetition overlaps with a PUSCH with dynamic grant, and the WCD either: (i) terminates the repetitions of the multiple slot TB starting from a starting symbol of the at least one symbol of the at least one repetition that overlaps the PUSCH with dynamic grant, (ii) cancels the at least one repetition that overlaps the PUSCH with dynamic grant, and/or (iii) postpones the at least one repetition that overlaps the PUSCH with dynamic grant.

In one embodiment, more than one multiple slot TB is transmitted within one period of the uplink configured grant.

In one embodiment, determining the PUSCH resources for transmission of the multiple slot TB comprises determining a number of available slots equal to a number of slots of the multiple slot TB as the PUSCH resource for transmission of a repetition of the multiple slot TB. In one embodiment, a same set of symbols is used in each slot of the repetition of the multiple slot TB.

In one embodiment, determining the PUSCH resources for transmission of the multiple slot TB comprises determining a number of available uplink symbols equal to a number of uplink symbols of the multiple slot TB as the PUSCH resource for transmission of a repetition of the multiple slot TB.

In one embodiment, the PUSCH resources are determined such that the WCD transmits K repetitions of the multiple slot TB.

In one embodiment, the PUSCH resources are determined such that the WCD transmits K repetitions of each of N segments of the multiple slot TB. In one embodiment, RV is cycled across transmission occasions or cycled across segments of the multiple slot TB.

In another embodiment, a method performed by a WCD comprises determining physical uplink shared channel, PUSCH, resources for transmission of a multiple slot transport block, determining that at least one slot of the multiple slot TB is unavailable, dropping transmission of only the unavailable slot of the multiple slot TB responsive to determining that at least one slot of the multiple slot TB is unavailable, and transmitting the multiple slot TB on the determined PUSCH resources.

In one embodiment, transmitting the multiple slot TB comprises transmitting a number, K, of repetitions of the multiple slot TB and dropping transmission of only the unavailable slot of the multiple slot TB further comprises dropping transmission of only the unavailable slot in the repetition of the multiple slot TB.

In one embodiment, a RV granularity for the multiple slot TB is all slots of a repetition of the multiple slot TB.

Corresponding embodiments of a WCD are also disclosed.

Embodiments of a base station or a network node that implements at least some of the functionality of a base station are also disclosed herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates examples of a transmission occasion of repetitions of a multi-slot transport block (TB) in accordance with an embodiment of the present disclosure;

FIG. 3 shows Option 1 of Embodiment 1 for resource determination for repetition of Type-B like multi-slot TB transmission with the Time Division Duplexing (TDD) configurations of (a) DDDSUDDDSU and (b) DDDSUDDSUU and Option 2 in (c);

FIG. 4 illustrates examples of alternative methods of resource determination for repetition of multi-slot TB;

FIG. 5 illustrates the operation of a network node and a WCD in accordance with at least some embodiments of the present disclosure;

FIG. 6 is a schematic block diagram of a radio access node according to some embodiments of the present disclosure;

FIG. 7 is a schematic block diagram that illustrates a virtualized embodiment of the radio access node of FIG. 6 according to some embodiments of the present disclosure;

FIG. 8 is a schematic block diagram of the radio access node of FIG. 6 according to some other embodiments of the present disclosure;

FIG. 9 is a schematic block diagram of a wireless communication device (WCD) according to some embodiments of the present disclosure;

FIG. 10 is a schematic block diagram of the WCD of FIG. 9 according to some other embodiments of the present disclosure;

FIG. 11 illustrates a telecommunication network connected via an intermediate network to a host computer in accordance with some embodiments of the present disclosure;

FIG. 12 is a generalized block diagram of a host computer communicating via a base station with a UE over a partially wireless connection in accordance with some embodiments of the present disclosure;

FIG. 13 is a flowchart illustrating a method implemented in a communication system in accordance with one embodiment of the present disclosure;

FIG. 14 is a flowchart illustrating a method implemented in a communication system in accordance with one embodiment of the present disclosure;

FIG. 15 is a flowchart illustrating a method implemented in a communication system in accordance with one embodiment of the present disclosure; and

FIG. 16 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device or WCD: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS) −only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenges in regard to Transport Block over Multi-Slot (TBoMS), e.g., in 3GPP NR. In NR Release 15/16, each Transport Block (TB) is within one slot and can have a Redundancy Version (RV). In NR Release 17, a TB can span multiple slots, and it is unclear whether the granularity of RV is one slot or multiple slots. One specific issue is how the UE can handle the transmission of TBoMS if one of the multiple slots of a TBoMS is an unavailable slot, e.g., semi-static downlink (DL).

In NR Release 15/16, the UE determines resources of PUSCH with configured grant based on a Starting symbol S. But a UE for TBoMS can have different S values in different slots. Another issue is whether repetition of TBoMS with configured grant can cross time duration of periodicity.

Another issue is about repetition of Type-B like TBoMS. The legacy PUSCH repetition Type A cannot be applied directly to Type-B like TBoMS. The Release 16 PUSCH repetition Type A requires that each repetition use the same symbols in a slot, but one repetition of Type-B like TBoMS uses different symbols in each slot. PUSCH repetition Type B may cause non-ideal segmentation.

Systems and methods are disclosed herein that provide solutions to the aforementioned or other challenges. Embodiments of the present disclosure provide resource determination for multi-slot TB transmission with or without repetition. In some embodiments, this includes, e.g., how to handle an unavailable slot, RV, and/or multi-slot TB with configured grant.

Embodiments of a method for repetition of Type B like TBoMS and an alternative method of repetition of TBoMS are also disclosed herein.

While not being limited by or to any particular advantages, embodiments of the present disclosure may provide one or more of the following advantages. Embodiments of the present disclosure may ensure robust PUSCH transmission via a TB over multiple slots while improving the resource utilization efficiency.

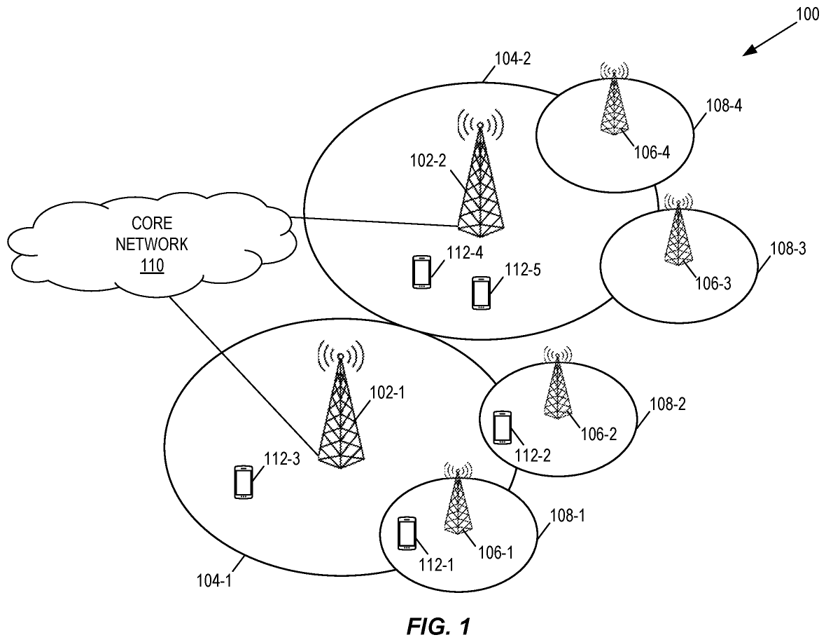

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the embodiments disclosed herein are not limited to the 5GS and may be used in any type of wireless or cellular communication system that utilizes uplink transmission of a transport block over multiple slots. In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5GC. The base stations 102 (and optionally the low power nodes 106) are connected to the core network 110.

The base stations 102 and the low power nodes 106 provide service to wireless communication devices (WCDs) 112-1 through 112-5 in the corresponding cells 104 and 108. The WCDs 112-1 through 112-5 are generally referred to herein collectively as WCDs 112 and individually as WCD 112. In the following description, the WCDs 112 are oftentimes UEs and as such sometimes referred to as UEs 112, but the present disclosure is not limited thereto.

As discussed above, in NR Release 15/16, one TB is within a slot, while NR Release 17 will support a TB over multiple slots (TBoMS, or multi-slot TB). Two types of TBoMS are being considered in 3GPP. Repetition of TBoMS is also under discussion. See, e.g., the following 3GPP agreement:
Agreement:
   Consider one or two of the following options as starting points to design time domain resource determination of TBoMS
      PUSCH repetition type A like TDRA, i.e., the number of allocated symbols is the same in each slot.
      PUSCH repetition type B like TDRA, i.e., the number of allocated symbols in each slot can be different

Issues discussed herein include the granularity for Redundancy Version (RV), how to handle an unavailable slot, and the number of slots for a TBoMS with configured grant. Both single transmission of TBoMS and repetition of TBoMS are considered for these issues. In addition, repetition of Type-B like TBoMS and an alternative method of resource determination for repetition of TBoMS are discussed.

RV cycling for repetition of TBoMS has previously been disclosed. In the present disclosure, different sizes of transmission occasion are defined as the granularity of RV (see, e.g., the section below entitled “The Granularity of RV for TBoMS”). The collision of TBoMS and other UL physical channel from the same UE has also previously been discussed. In the present disclosure, semi-static DL slots or UL transmission from other UE(s) are considered as unavailable slots (see, e.g., the section below entitled “Methods to Handle Unavailable Slot”).

If a UE 112 is configured to transmit a TBoMS over N slots with K repetitions, the total number of slots needed for the transmission equals N*K. Considering the latency requirement of a TB, the maximum value of N*K can be upper bounded.

In one embodiment, for the repetition of a TBoMS, some rule can be applied to the number of repetitions K and number of slots N for a TBoMS. For example, in one embodiment, the maximum number of repetitions (i.e., the maximum value of N*K) is predetermined and enforced by applying a respective rule (e.g., rule that N*K is less than or equal to a predefined maximum value). As one example, the maximum value is 32.

### The Granularity of RV for TBoMS

By defining the multiple slots of a multi-slot TB as a single RV and a smallest unit of PUSCH for repetition, it is possible to extend Release 15/16 structures for repetition to multi-slot TB operation. As discussed above, in Release 15/16, both Type A and Type B repetition follow the pattern defined in section 6.1.2.1 of 3GPP TS 38.214 v 16.4.0. The redundancy version to be applied on the nth transmission occasion of the TB, where n=0, 1, . . . K−1, is determined according to table 6.1.2.1-2 of 3GPP TS 38.214 v16.4.0, which is reproduced below as Table 1.

TABLE 1
Reproduction of Table 6.1.2.1-2: Redundancy
version for PUSCH transmission

| rv_{id} indicated | rv_{id} to be applied to n^{th} transmission occasion | | | |
|---|---|---|---|---|
| by the DCI | (repetition Type A) or n^{th} actual repetition | | | |
| scheduling | (repetition Type B) | | | |
| the PUSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

In one embodiment, a transmission occasion of a multi-slot TB can be all slots of the TBoMS or part of all slots of the TBoMS or a single slot of all slots of the TBoMS. The transmission occasion is the granularity of RV, and RV can be cycled across transmission occasions according to a predefined or configured RV cycling pattern (e.g., the predefined RV cycling pattern of 3GPP TS 38.214). Namely, if there are multiple transmission occasions for a TBoMS, RV can be cycled across the multiple transmission occasions of a TBoMS. If repetition of a multi-slot TB is configured, RV can be cycled across transmission occasions of repetitions of the TBoMS.

In another embodiment, the RV, which may be predetermined or indicated by DCI or high layer, applies to the first transmission occasion of the multi-slot TB or the first transmission occasion of the first repetition of the multi-slot TB if repetition is configured.

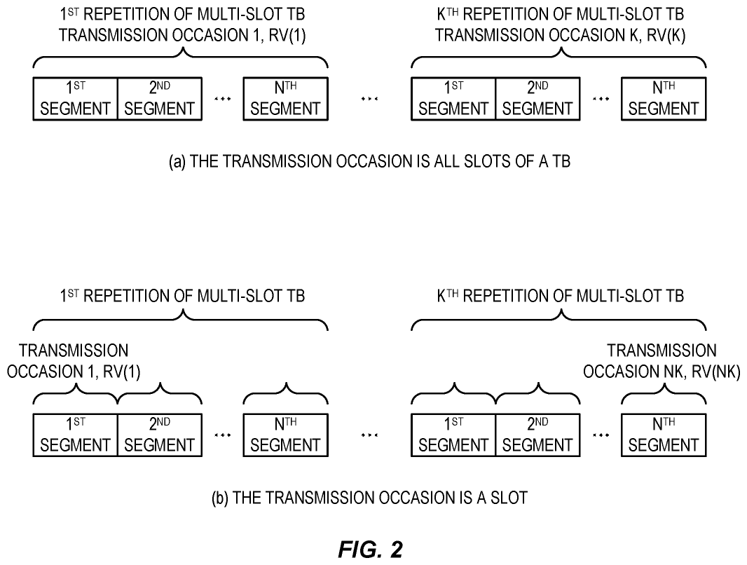

FIG. 2 illustrates examples of a transmission occasion of repetitions of a multi-slot TB in accordance with an embodiment of the present disclosure. In the present disclosure, the RV in transmission occasion n is denoted by RV(n). As illustrated in FIG. 2(a), in one example, the nth transmission occasion (for at least the purpose of calculating an RV) is the nth transmission of all slots of the multi-slot TB. The RV is cycled from RV(1) to RV(K) across the K repetitions, i.e. K transmission occasions. In the example of FIG. 2(b), the nth transmission occasion of a multi-slot TB is defined as a single slot of the multi-slot TB, and each slot of the multi-slot TB is first cycled according to the redundancy version. RV is cycled from RV(1) to RV(NK) across N*K transmission occasions.

### Methods to Handle Unavailable Slot

In NR operation, there are cases where a UE 112 should not transmit in a slot, such as a downlink slot in Time Division Duplexing (TDD), where the transmission would conflict with a transmission from the UE 112 or another UE etc. In these cases, the slot is considered as an unavailable slot for the uplink transmission. When the UE 112 should not transmit, it is possible to defer the uplink transmission in some cases. However, for multi-slot TB transmission of a single RV, it is much more likely that deferring a segment of the multi-slot TB to a later slot will make the non-deferred portion of the transmission undecodable, since it is much more likely that there will be an insufficient number of systematic bits if a portion of a TB is deferred for multi-slot TB than for simple repetition. Therefore, multi-slot TB deferral is more sensitive than repetition to latency. As such, it can be disadvantageous to defer a segment of a multi-slot TB transmission, and therefore preferable to drop the slot of the multi-slot transmission rather than defer it.

In one embodiment, if at least one of all slots of a multi-slot TB is unavailable for the transmission of multi-slot TB, one or more of below methods can be used.
Option 1: The UE 112 drops all slots of the multi-slot TB.
Option 2: The UE 112 drops the transmission in the slot and also drops all remaining slots of the multi-slot TB.
Option 3: The UE 112 only drops the transmission in the unavailable slot.
Option 4: The UE 112 drops the transmission in a subset of all slots of multi-slot TB, where the subset of all slots in which the transmission is dropped constitute a transmission occasion that overlaps with the unavailable slot.

One use case of Option 2 is when dynamic signaling, e.g., cancellation indication, is considered by the UE 112 and changes one slot into unavailable slot.

In another embodiment, if the UE 112 is configured with repetitions of a TBoMS and at least one of all slots of a repetition of the TBoMS is unavailable, one or more of below methods can be used.
Option 1: The UE 112 drops the repetition of TBoMS.
Option 2: The UE 112 drops the transmission in the slot and also drops the transmissions in the remaining slots of the repetition.
Option 3: The UE 112 only drops the transmission in the unavailable slot of the repetition. For an example of Option 3 for repetitions of a TBoMS, regarding an N-slot TB transmission with two repetitions and one RV per TB, the UE 112 encodes a set of information bits producing encoded bits of a first RV and a second RV. The UE 112 maps the encoded bits of the first and second RVs respectively across a first and second sets of N slots, where the second set of N slots is after the first set of N slots in time. Each of N segments of each RV are one-to-one mapped to a slot in the corresponding first or second set of slots. The UE 112 determines if each slot of the first and second set of slots is available for transmission. If a slot is available, the UE 112 transmits the corresponding segment of the RV in the slot. If it is not available, the corresponding segment is not transmitted, and the UE 112 proceeds to the next segment.

Some base station 102 (e.g., gNB) scheduling restriction(s) can be considered. In another embodiment, if configured with repetition of TBoMS with dynamic grant, the UE 112 is not expected to have an unavailable slot for the transmission of the first repetition of TBoMS.

Resources Determination for TB over Multiple Slots with Configured Grant

In NR Release 16, Starting symbol S is used to determine the PUSCH resource for a TB in a slot (see excerpt from 3GPP TS 38.321 v16.3.0 below in Table 2). However, a multi-slot TB, especially Type-B like multi-slot TB, has multiple S values in multiple slots.

TABLE 2
Upon configuration of a configured grant Type 1 for a BWP of a Serving
Cell by upper layers, the MAC entity shall:
1> store the uplink grant provided by upper layers as a configured uplink
grant for the indicated BWP of the Serving Cell;
1> initialise or re-initialise the configured uplink grant to start in the
symbol according to timeDomainOffset, timeReferenceSFN, and S
(derived from SLIV or provided by startSymbol as specified in TS
38.214), and to reoccur with periodicity.

In a first embodiment, the start symbol S used to initialize or re-initialize the configured uplink grant can be determined based on one or more of the following methods:
S is the starting symbol in any of the multiple slots of the TB.
   E.g., when the S in different slots has the same value, the S can be the common S for any slot.
S is the starting symbol in the first slot of the multiple slots of the TB.
   E.g., for Type B like TB over multiple slots, when the starting symbol may be different from each other in different slots, the starting symbol index of the first slot can be used.
S is the starting symbol in a slot which is determined by RRC configuration.
S is the starting symbol in the slot selected for HARQ ID determination.

In a second embodiment, the UE 112 is not expected to be configured with the time duration for the transmission of a TBoMS with configured grant larger than the time duration derived by the periodicity P.

In a third embodiment, the UE 112 is not expected to transmit a multi-slot TB over a set of slots across CG periodicity. In other words, the UE 112 is not expected to transmit a multi-slot TB that crosses a boundary between two adjacent periods of the uplink CG.

The UE 112 starts the timer configuredGrantTimer from the first symbols of the transmission of a TB. If no explicit NACK is received before the timer expires, the UE 112 assumes ACK. The timer is defined to be multiples of periodicity. With the first and second embodiments above, the timer will not expire before the UE 112 finishes the transmission of TBoMS.

If the UE 112 is configured with repetition of TBoMS with a configured grant, the number of repetitions of a TBoMS may be smaller than number of repetitions of single-slot TB, so as to have all repetitions of the TB within the periodicity P. But considering the enhanced repetition mechanism on the basis of available slot, the repetition may span longer time duration for a TDD system, increasing the possibility to have repetition across the periodicity border. Therefore, some gNB scheduling restriction or UE behavior restriction can be imposed.

In a fourth embodiment, if the UE 112 is configured with K repetitions for a TBoMS with configured grant, one or more of the rules below can be applied.
The UE 112 is not expected to be configured with the time duration for the transmission of K repetitions of a TBoMS larger than the time duration of a CG periodicity P.
   For example, K<=floor(P in the unit of slot/number of slots for a TBoMS)
If the time duration for the transmission of K repetitions of the TBoMS is larger than the time duration derived by the CG periodicity P, the actual transmission of repetitions of the TBoMS is within the time duration of periodicity P and do not span multiple time durations.
   if the UE 112 is configured with K repetitions for a TBoMS with configured grant, after the UE 112 transmits X repetition(s) of the TBoMS, X<K, if the UE 112 determines that the remaining available resources within the time duration of periodicity P are not enough for the transmission of a repetition of the TBoMS, one or more of below methods can be used.
      The UE 112 does not transmit the remaining repetition(s) in the remaining resources.
      The UE 112 transmits the remaining repetition(s) in the remaining resources until the end of this time duration of periodicity P.

In a fifth embodiment, if the UE 112 is configured with repetitions for a TBoMS with configured grant and at least one symbol of a repetition overlaps in time with a PUSCH with the same HARQ process scheduled by DCI format 0_0, 0_1 or 0_2, one or more of below methods can be used.
The repetitions shall be terminated from the starting symbol of the repetition that overlaps with a PUSCH with dynamic grant.
The UE 112 cancels the repetition which overlaps with the PUSCH with dynamic grant and transmits remaining repetitions of the TBoMS in the periodicity.
The UE 112 postpones the repetition which overlaps with the PUSCH with dynamic grant to the next available symbol or slot in the periodicity.

In a sixth embodiment, more than one TBoMS can be configured in one periodicity.

Resource Determination for Repetition of Type-B like TBoMS

Type-B like TBoMS can have different number of allocated symbols in each slot. One example of Type-B like TBoMS is the use of fewer-than-fourteen UL symbols in a special slot and the UL symbols in the following UL slot(s) to form a TB.

In a first embodiment, the UE 112 can be configured (e.g., via RRC or DCI or a combination thereof) or predetermined with one or more of below methods for repetition of Type-B like TBoMS.
Option 1: The UE 112 determines a number of available slots equal to the number of slots of a TBoMS as resource for transmission of a repetition. The UE 112 uses the same set of symbols in the same indexed slot of TBoMS in each repetition. In other words, the UE 112 uses the same set of symbols in the first slot of TBoMS in each repetition, the same set of symbols in the second slot of TBoMS in each repetition, till the last slot of TBoMS in each repetition.
   If a TBoMS starts from a S slot, the UE 112 can be configured if all repetitions have to start from S slot.
Option 2: The UE 112 determines a number of available UL symbols equal to the number of UL symbols of TBoMS as resource for transmission of a repetition.

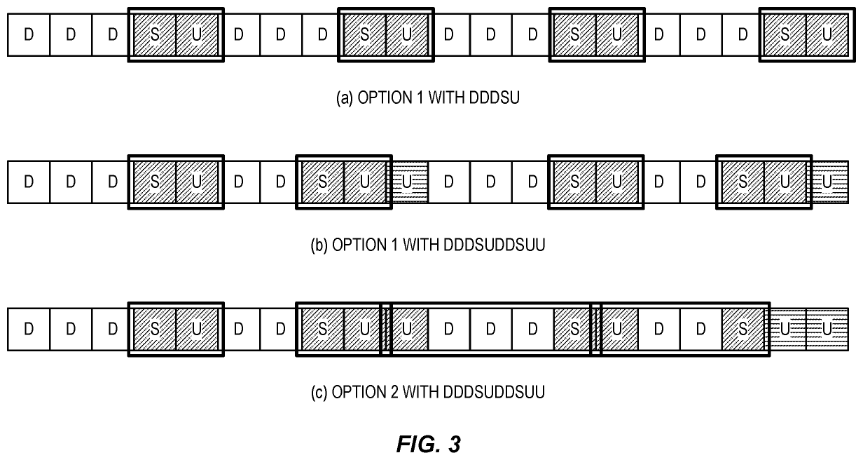

Take an example of four repetitions of a TB over one S slot and one UL slot. FIG. 3 shows Option 1 with the TDD configurations of (a) DDDSUDDDSU and (b) DDDSUDDSUU and Option 2 in (c). With 15 kHz subcarrier spacing (SCS), the UE 112 can transmit four repetitions of the TB in two subframes. The two yellow slots within a thick border are used for transmission of one repetition of TBoMS. In (b) with DDDSUDDSUU, if the UE 112 is configured to start each repetition from S slot, the UE 112 searches for the available S slot and the subsequent U slot as candidate transmission occasion. The last UL slot in a subframe, marked with horizontal hashing, is not used for the repetition. In (c), the third and fourth repetitions of TBoMS span non-consecutive slots. The UE 112 uses different sets of symbols in the latter two repetitions from the first two repetitions.

### An Alternative Method of Resource Determination for Repetition of TBoMS

In addition to resource determination for repetition of multi-slot TB with one repetition of the multi-slot TB after another as illustrated in FIG. 2, there is an alternative method.

In one embodiment, if the UE 112 is configured to transmit repetitions of a multi-slot TB, the UE 112 can first send repetitions of the first segment, followed by repetitions of the second segment, till repetitions of the last segment of the multi-slot TB. One segment equals a transmission occasion, which can be a slot or part of all slots of a TBoMS.

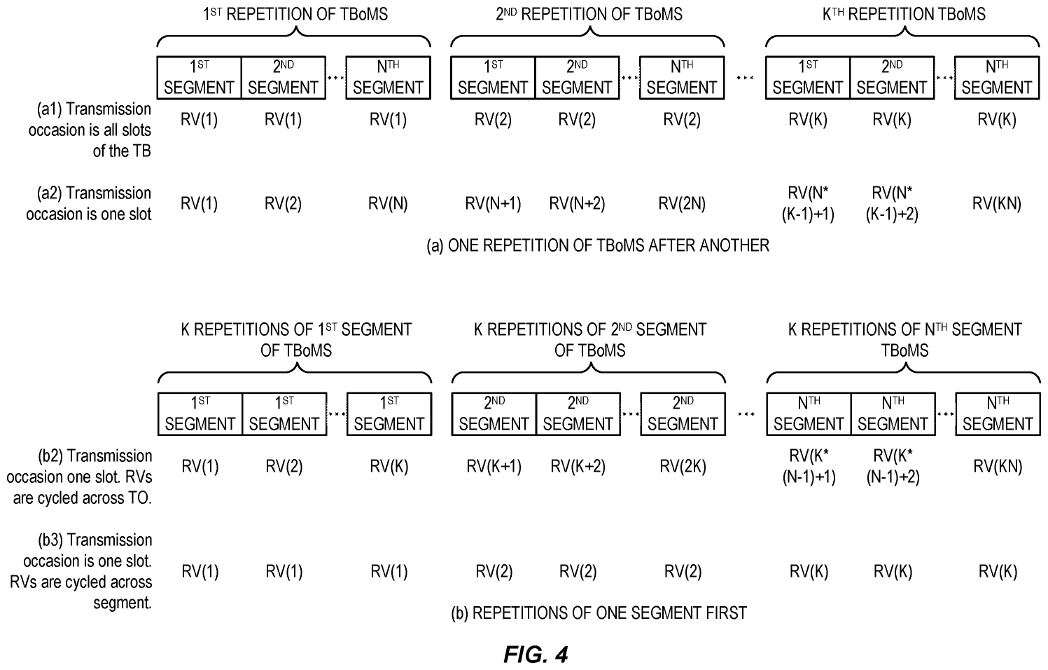

FIG. 4 illustrates examples of alternative methods of resource determination for repetition of multi-slot TB. More specifically, FIGS. 4(a1) and (a2) show two examples of the transmission of one repetition of TBoMS after another. FIGS. 4(b1) and (b2) show two examples of the alternative method of transmission of repetitions of one segment followed by repetitions of another segment. While cycling RV first allows a given segment of a multi-slot TB to receive all parity bits for the segment as quickly as possible, allowing the most robust transmission of that segment, the remaining segments are delayed until all RVs of the prior segments are transmitted. Since the network may decode the multi-slot TB using only a subset of RVs when the SINR is sufficiently high, transmitting in an RV-first manner may waste resources used for multi-slot TB transmission. Therefore, it is desirable in some applications to transmit the entirety of an RV of a multi-slot TB prior to transmitting a new RV of the multi-slot TB.

In a sub-embodiment, with a transmission occasion being one segment, RV can be cycled in one or more of below methods.
RV can be cycled across transmission occasions.
RV can be cycled across segments. Namely, repetitions of one segment use one RV.

The two methods are illustrated as (b2) and (b3) in FIG. 4.

### Additional Description

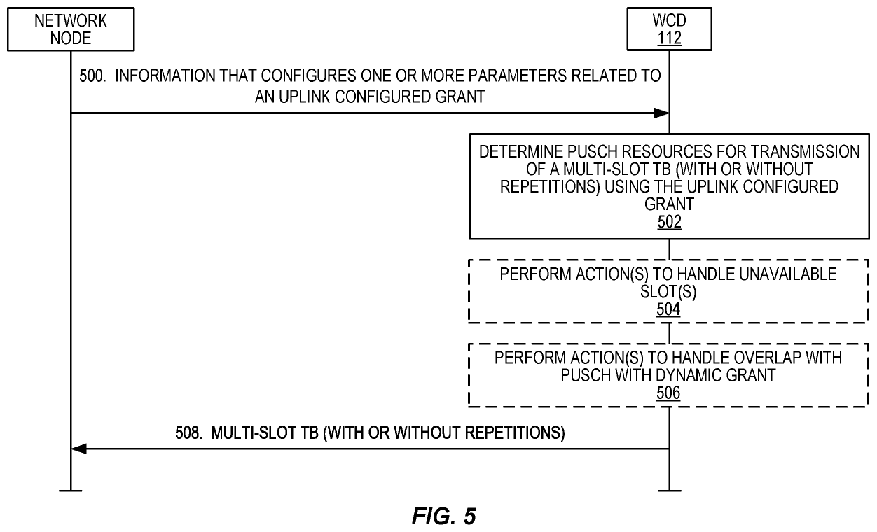

FIG. 5 illustrates the operation of a network node (e.g., a base station 102 (e.g., a gNB) or a network node that performs at least some of the functionality of the base station 102) and a WCD 112 (e.g., a UE) in accordance with at least some of the embodiments described above. Note that optional steps are represented by dashed lines/boxes. As illustrated, the network node sends, and the WCD 112 receives, information that configures one or more parameters for at least one uplink configured grant (step 500). The uplink configured grant may be, for example, a NR Type 1 configured grant or a NR Type 2 configured grant. The one or more parameters may include, for example, a periodicity of the configured grant and information that indicates a starting symbol or information from which the WCD 112 derives the starting symbol.

The WCD 112 determines PUSCH resources for transmission of a multi-slot TB (with or without repetitions, e.g., depending on whether repetitions are configured) using the configured grant, based on the one or more parameters (step 502). Optionally, in some embodiments, the WCD 112 performs one or more actions to handle one or more unavailable slots within the slots of the multi-slot TB or within the slots of a repetition of the multi-slot TB (step 504). Optionally, in some embodiments, the WCS 112 performs one or more actions to handle an overlap between a PUSCH with a dynamic grant and a slot(s) of the multi-slot TB or a slot(s) of a repetition of the multi-slot TB (step 506). The WCD 112 transmits the multi-slot TB (with or without transmissions) one the determined PUSCH resources (step 508).

In one embodiment, a maximum number of repetitions for the multiple slot TB is preconfigured or predefined.

In one embodiment, a redundancy version (RV) granularity for the multiple slot TB is: (a) all slots of the multiple slot TB, (b) a subset of all slots of the multiple slot TB, or (c) a single slot of the multiple slot TB. In another embodiment, at the WCD 112, transmitting the multiple slot TB comprises transmitting a number, K, of repetitions of the multiple slot TB, and a RV granularity for the multiple slot TB is: (a) all slots of a repetition of the multiple slot TB, (b) a subset of all slots of a repetition of the multiple slot TB, or (c) a single slot of a repetition of the multiple slot TB. In one embodiment, a predetermined or indicated RV applies to a first transmission occasion of the multiple slot TB or a first transmission occasion of a first repetition of the multiple slot TB.

In one embodiment, the method further comprises, at the WCD 112, determining that at least one slot of the multiple slot TB is unavailable and, responsive to determining that at least one slot of the multiple slot TB is unavailable, either: dropping transmission of all slots of the multiple slot TB, dropping transmission of the unavailable slot and all remaining slots of the multiple slot TB, dropping transmission of only the unavailable slot of the multiple slot TB, or dropping transmission of a subset of all slots of the multiple slot TB, where the subset corresponds to a transmission occasion that comprises the unavailable slot. This is done in step 504.

In one embodiment, at the WCD 112, transmitting the multiple slot TB comprises transmitting a number, K, of repetitions of the multiple slot TB, and the method further comprises, at the WCD 112, determining that at least one slot of a repetition of the multiple slot TB is unavailable and, responsive thereto, dropping transmission of all slots in the repetition of the multiple slot TB, dropping transmission of the unavailable slot and all remaining slots in the repetition of the multiple slot TB, or dropping transmission of only the unavailable slot in the repetition of the multiple slot TB.

In one embodiment, the WCD is not expected to have an unavailable slot for transmission of a first repetition of the multiple slot TB.

In one embodiment, at the WCD 112, determining the PUSCH resources for transmission of the multiple slot TB comprises determining a starting symbol, S, within a slot of the multiple slot TB. In one embodiment, the starting symbol, S, is a common starting symbol, S, value for at least a subset of (e.g., all of) the slots of the multiple slot TB. In one embodiment, the starting symbol, S, is a starting symbol, S, for a first slot from among the slots of the multiple slot TB. In one embodiment, the starting symbol, S, is a starting symbol, S, for a particular slot from among the slots of the multiple slot TB determined by the WCD based on signaling from the base station or predefined rule. In one embodiment, the starting symbol, S, is a starting symbol, S, for a particular slot from among the slots of the multiple slot TB that is selected for Hybrid Automatic Repeat Request (HARQ) identity determination.

In one embodiment, a duration of the multi-slot TB or a duration of all repetitions of the multi-slot TB is less than a time duration that corresponds to a periodicity of the uplink configured grant.

In one embodiment, a value of a configured grant timer associated to the uplink configured grant is a multiple of a duration of the multi-slot TB.

In one embodiment, the WCD 112 is configured with K repetitions for the multiple slot TB with the uplink configured grant, and: (i) the WCD 112 is not expected to be configured with a time duration for transmission of the K repetitions of the multiple slot TB that is greater than a time duration of a periodicity of the uplink configured grant; and/or (ii) the time duration for the transmission of the K repetitions of the multiple slot TB is greater than the periodicity of the uplink configured grant, remaining resources within the time duration of the periodicity of the uplink configured grant after transmitting repetition X of the multiple slot TB, where X<K, is not sufficient to transmit a repetition of the multiple slot TB, and the WCD 112 either: (I) does not transmit the remaining repetition(s) of the multiple slot TB or (II) transmits the remaining repetition(s) of the multiple slot TB until reaching an end of the time duration of the periodicity of the uplink configured grant.

In one embodiment, the WCD is configured with K repetitions for the multiple slot TB with the uplink configured grant, at least one symbol of at least one repetition overlaps with a PUSCH with dynamic grant, and the WCD either: (i) terminates the repetitions of the multiple slot TB starting from a starting symbol of the at least one symbol of the at least one repetition that overlaps the PUSCH with dynamic grant, (ii) cancels the at least one repetition that overlaps the PUSCH with dynamic grant, and/or (iii) postpones the at least one repetition that overlaps the PUSCH with dynamic grant.

In one embodiment, more than one multiple slot TB is transmitted within one period of the uplink configured grant.

In one embodiment, at the WCD 112, determining the PUSCH resources for transmission of the multiple slot TB comprises determining a number of available slots equal to a number of slots of the multiple slot TB as the PUSCH resource for transmission of a repetition of the multiple slot TB. In one embodiment, a same set of symbols is used in each slot of the repetition of the multiple slot TB.

In one embodiment, at the WCD 112, determining the PUSCH resources for transmission of the multiple slot TB comprises determining a number of available uplink symbols equal to a number of uplink symbols of the multiple slot TB as the PUSCH resource for transmission of a repetition of the multiple slot TB.

In one embodiment, the PUSCH resources are determined such that the WCD transmits K repetitions of the multiple slot TB.

In one embodiment, the PUSCH resources are determined such that the WCD transmits K repetitions of each of N segments of the multiple slot TB. In one embodiment, RV is cycled across transmission occasions or cycled across segments of the multiple slot TB.

Note that further details of various aspects of the embodiments described herein are described in the sections above and are equally applicable here to the description of the process of FIG. 5.

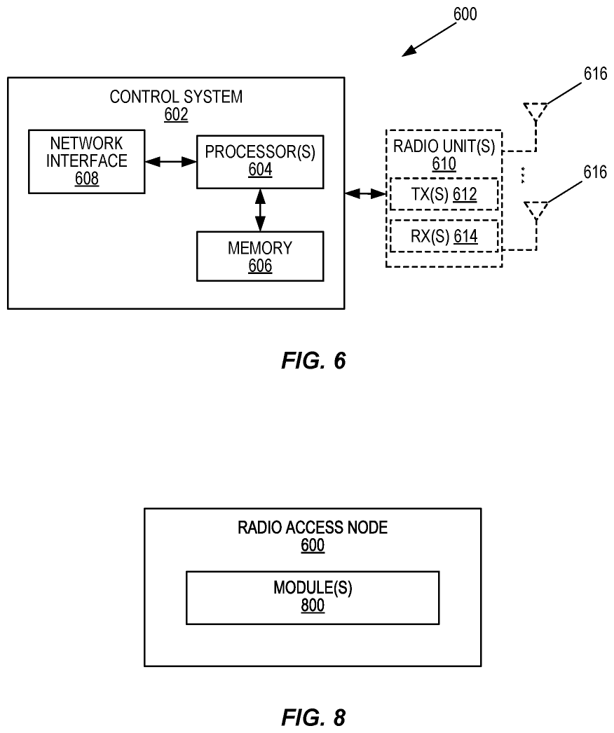

FIG. 6 is a schematic block diagram of a radio access node 600 according to some embodiments of the present disclosure. Optional features are represented by dashed boxes. The radio access node 600 may be, for example, a base station 102 or 106 or a network node that implements all or part of the functionality of the base station 102 or gNB described herein. As illustrated, the radio access node 600 includes a control system 602 that includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. In addition, the radio access node 600 may include one or more radio units 610 that each includes one or more transmitters 612 and one or more receivers 614 coupled to one or more antennas 616. The radio units 610 may be referred to or be part of radio interface circuitry. In some embodiments, the radio unit(s) 610 is external to the control system 602 and connected to the control system 602 via, e.g., a wired connection (e.g., an optical cable). However, in some other embodiments, the radio unit(s) 610 and potentially the antenna(s) 616 are integrated together with the control system 602. The one or more processors 604 operate to provide one or more functions of a radio access node 600 as described herein. In some embodiments, the function(s) are implemented in software that is stored, e.g., in the memory 606 and executed by the one or more processors 604.

FIG. 7 is a schematic block diagram that illustrates a virtualized embodiment of the radio access node 600 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 600 in which at least a portion of the functionality of the radio access node 600 is implemented as a virtual component(s) (e.g., via a virtual machine(s) executing on a physical processing node(s) in a network(s)). As illustrated, in this example, the radio access node 600 may include the control system 602 and/or the one or more radio units 610, as described above. The control system 602 may be connected to the radio unit(s) 610 via, for example, an optical cable or the like. The radio access node 600 includes one or more processing nodes 700 coupled to or included as part of a network(s) 702. If present, the control system 602 or the radio unit(s) are connected to the processing node(s) 700 via the network 702. Each processing node 700 includes one or more processors 704 (e.g., CPUs, ASICs, FPGAs, and/or the like), memory 706, and a network interface 708.

In this example, functions 710 of the radio access node 600 described herein are implemented at the one or more processing nodes 700 or distributed across the one or more processing nodes 700 and the control system 602 and/or the radio unit(s) 610 in any desired manner. In some particular embodiments, some or all of the functions 710 of the radio access node 600 described herein are implemented as virtual components executed by one or more virtual machines implemented in a virtual environment(s) hosted by the processing node(s) 700. As will be appreciated by one of ordinary skill in the art, additional signaling or communication between the processing node(s) 700 and the control system 602 is used in order to carry out at least some of the desired functions 710. Notably, in some embodiments, the control system 602 may not be included, in which case the radio unit(s) 610 communicate directly with the processing node(s) 700 via an appropriate network interface(s).

In some embodiments, a computer program including instructions which, when executed by at least one processor, causes the at least one processor to carry out the functionality of radio access node 600 or a node (e.g., a processing node 700) implementing one or more of the functions 710 of the radio access node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the radio access node 600 according to some other embodiments of the present disclosure. The radio access node 600 includes one or more modules 800, each of which is implemented in software. The module(s) 800 provide the functionality of the radio access node 600 described herein. This discussion is equally applicable to the processing node 700 of FIG. 7 where the modules 800 may be implemented at one of the processing nodes 700 or distributed across multiple processing nodes 700 and/or distributed across the processing node(s) 700 and the control system 602.

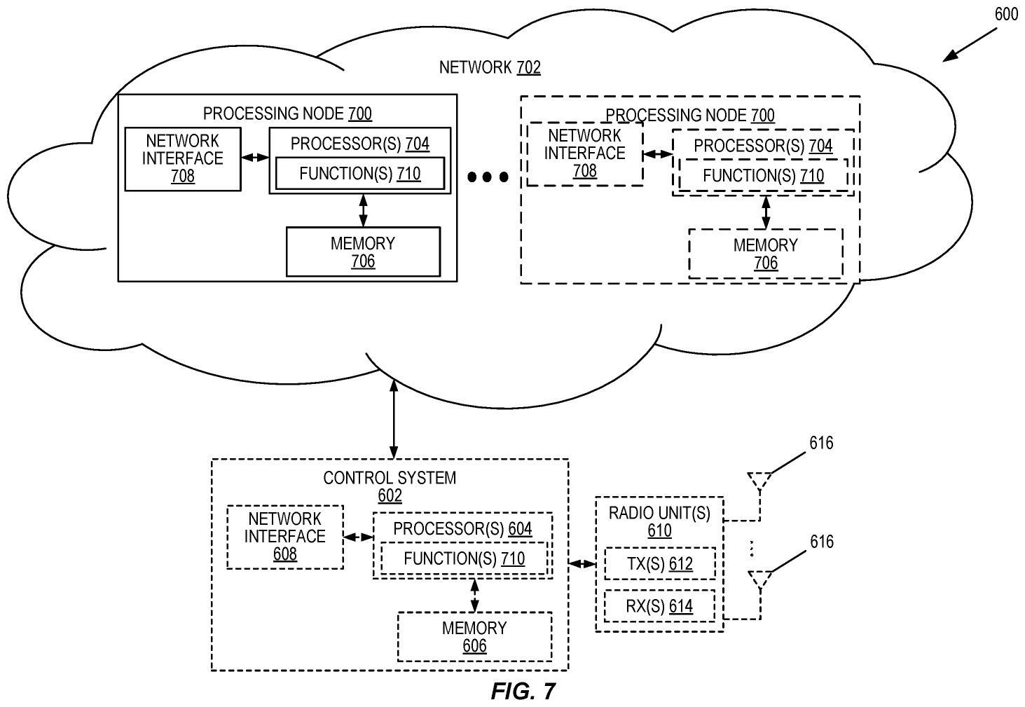

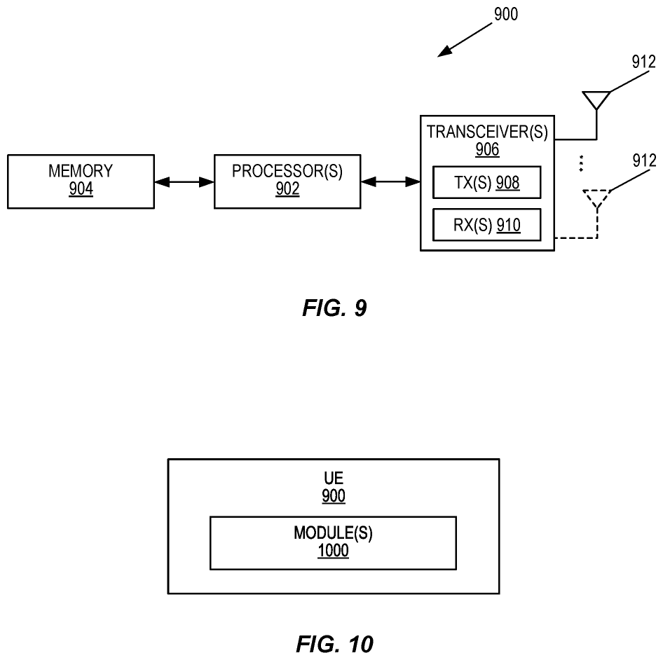

FIG. 9 is a schematic block diagram of a WCD 112 according to some embodiments of the present disclosure. As illustrated, the WCD 112 includes one or more processors 902 (e.g., CPUs, ASICs, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the WCD 112 described above may be fully or partially implemented in software that is, e.g., stored in the memory 904 and executed by the processor(s) 902. Note that the WCD 112 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the WCD 112 and/or allowing output of information from the WCD 112), a power supply (e.g., a battery and associated power circuitry), etc.

In some embodiments, a computer program including instructions which, when executed by at least one processor, causes the at least one processor to carry out the functionality of the WCD 112 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the WCD 112 according to some other embodiments of the present disclosure. The WCD 112 includes one or more modules 1000, each of which is implemented in software. The module(s) 1000 provide the functionality of the WCD 112 described herein.

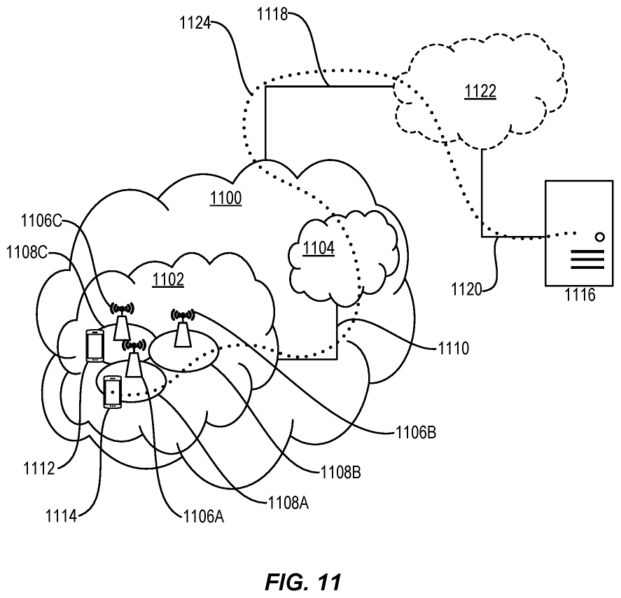

With reference to FIG. 11, in accordance with an embodiment, a communication system includes a telecommunication network 1100, such as a 3GPP-type cellular network, which comprises an access network 1102, such as a RAN, and a core network 1104. The access network 1102 comprises a plurality of base stations 1106A, 1106B, 1106C, such as Node Bs, eNBs, gNBs, or other types of wireless Access Points (APs), each defining a corresponding coverage area 1108A, 1108B, 1108C. Each base station 1106A, 1106B, 1106C is connectable to the core network 1104 over a wired or wireless connection 1110. A first UE 1112 located in coverage area 1108C is configured to wirelessly connect to, or be paged by, the corresponding base station 1106C. A second UE 1114 in coverage area 1108A is wirelessly connectable to the corresponding base station 1106A. While a plurality of UEs 1112, 1114 are illustrated in this example, the disclosed embodiments are equally applicable to a situation where a sole UE is in the coverage area or where a sole UE is connecting to the corresponding base station 1106.

The telecommunication network 1100 is itself connected to a host computer 1116, which may be embodied in the hardware and/or software of a standalone server, a cloud-implemented server, a distributed server, or as processing resources in a server farm. The host computer 1116 may be under the ownership or control of a service provider, or may be operated by the service provider or on behalf of the service provider. Connections 1118 and 1120 between the telecommunication network 1100 and the host computer 1116 may extend directly from the core network 1104 to the host computer 1116 or may go via an optional intermediate network 1122. The intermediate network 1122 may be one of, or a combination of more than one of, a public, private, or hosted network; the intermediate network 1122, if any, may be a backbone network or the Internet; in particular, the intermediate network 1122 may comprise two or more sub-networks (not shown).

The communication system of FIG. 11 as a whole enables connectivity between the connected UEs 1112, 1114 and the host computer 1116. The connectivity may be described as an Over-the-Top (OTT) connection 1124. The host computer 1116 and the connected UEs 1112, 1114 are configured to communicate data and/or signaling via the OTT connection 1124, using the access network 1102, the core network 1104, any intermediate network 1122, and possible further infrastructure (not shown) as intermediaries. The OTT connection 1124 may be transparent in the sense that the participating communication devices through which the OTT connection 1124 passes are unaware of routing of uplink and downlink communications. For example, the base station 1106 may not or need not be informed about the past routing of an incoming downlink communication with data originating from the host computer 1116 to be forwarded (e.g., handed over) to a connected UE 1112. Similarly, the base station 1106 need not be aware of the future routing of an outgoing uplink communication originating from the UE 1112 towards the host computer 1116.

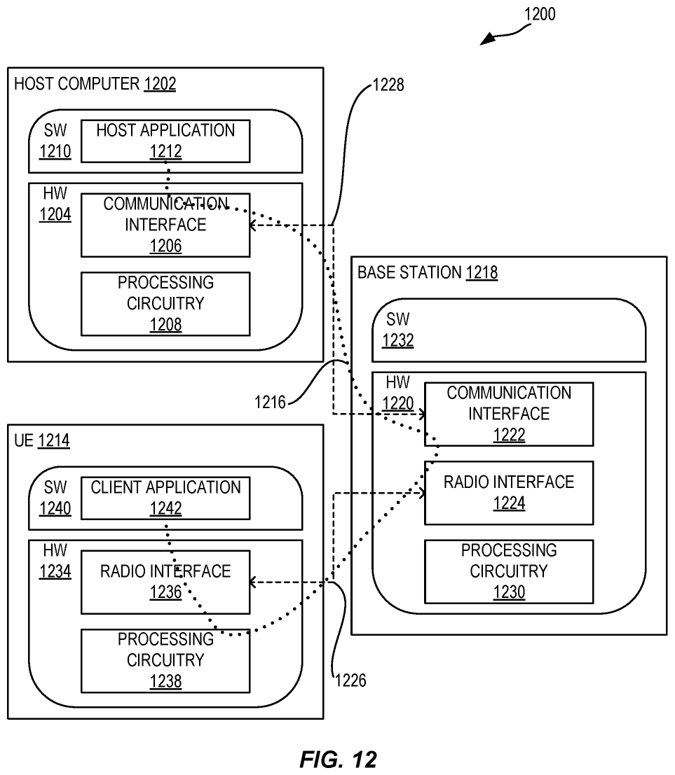

Example implementations, in accordance with an embodiment, of the UE, base station, and host computer discussed in the preceding paragraphs will now be described with reference to FIG. 12. In a communication system 1200, a host computer 1202 comprises hardware 1204 including a communication interface 1206 configured to set up and maintain a wired or wireless connection with an interface of a different communication device of the communication system 1200. The host computer 1202 further comprises processing circuitry 1208, which may have storage and/or processing capabilities. In particular, the processing circuitry 1208 may comprise one or more programmable processors, ASICs, FPGAs, or combinations of these (not shown) adapted to execute instructions. The host computer 1202 further comprises software 1210, which is stored in or accessible by the host computer 1202 and executable by the processing circuitry 1208. The software 1210 includes a host application 1212. The host application 1212 may be operable to provide a service to a remote user, such as a UE 1214 connecting via an OTT connection 1216 terminating at the UE 1214 and the host computer 1202. In providing the service to the remote user, the host application 1212 may provide user data which is transmitted using the OTT connection 1216.

The communication system 1200 further includes a base station 1218 provided in a telecommunication system and comprising hardware 1220 enabling it to communicate with the host computer 1202 and with the UE 1214. The hardware 1220 may include a communication interface 1222 for setting up and maintaining a wired or wireless connection with an interface of a different communication device of the communication system 1200, as well as a radio interface 1224 for setting up and maintaining at least a wireless connection 1226 with the UE 1214 located in a coverage area (not shown in FIG. 12) served by the base station 1218. The communication interface 1222 may be configured to facilitate a connection 1228 to the host computer 1202. The connection 1228 may be direct or it may pass through a core network (not shown in FIG. 12) of the telecommunication system and/or through one or more intermediate networks outside the telecommunication system. In the embodiment shown, the hardware 1220 of the base station 1218 further includes processing circuitry 1230, which may comprise one or more programmable processors, ASICs, FPGAs, or combinations of these (not shown) adapted to execute instructions. The base station 1218 further has software 1232 stored internally or accessible via an external connection.

The communication system 1200 further includes the UE 1214 already referred to. The UE's 1214 hardware 1234 may include a radio interface 1236 configured to set up and maintain a wireless connection 1226 with a base station serving a coverage area in which the UE 1214 is currently located. The hardware 1234 of the UE 1214 further includes processing circuitry 1238, which may comprise one or more programmable processors, ASICs, FPGAs, or combinations of these (not shown) adapted to execute instructions. The UE 1214 further comprises software 1240, which is stored in or accessible by the UE 1214 and executable by the processing circuitry 1238. The software 1240 includes a client application 1242. The client application 1242 may be operable to provide a service to a human or non-human user via the UE 1214, with the support of the host computer 1202. In the host computer 1202, the executing host application 1212 may communicate with the executing client application 1242 via the OTT connection 1216 terminating at the UE 1214 and the host computer 1202. In providing the service to the user, the client application 1242 may receive request data from the host application 1212 and provide user data in response to the request data. The OTT connection 1216 may transfer both the request data and the user data. The client application 1242 may interact with the user to generate the user data that it provides.

It is noted that the host computer 1202, the base station 1218, and the UE 1214 illustrated in FIG. 12 may be similar or identical to the host computer 1116, one of the base stations 1106A, 1106B, 1106C, and one of the UEs 1112, 1114 of FIG. 11, respectively. This is to say, the inner workings of these entities may be as shown in FIG. 12 and independently, the surrounding network topology may be that of FIG. 11.

In FIG. 12, the OTT connection 1216 has been drawn abstractly to illustrate the communication between the host computer 1202 and the UE 1214 via the base station 1218 without explicit reference to any intermediary devices and the precise routing of messages via these devices. The network infrastructure may determine the routing, which may be configured to hide from the UE 1214 or from the service provider operating the host computer 1202, or both. While the OTT connection 1216 is active, the network infrastructure may further take decisions by which it dynamically changes the routing (e.g., on the basis of load balancing consideration or reconfiguration of the network).

The wireless connection 1226 between the UE 1214 and the base station 1218 is in accordance with the teachings of the embodiments described throughout this disclosure. One or more of the various embodiments improve the performance of OTT services provided to the UE 1214 using the OTT connection 1216, in which the wireless connection 1226 forms the last segment.

A measurement procedure may be provided for the purpose of monitoring data rate, latency, and other factors on which the one or more embodiments improve. There may further be an optional network functionality for reconfiguring the OTT connection 1216 between the host computer 1202 and the UE 1214, in response to variations in the measurement results. The measurement procedure and/or the network functionality for reconfiguring the OTT connection 1216 may be implemented in the software 1210 and the hardware 1204 of the host computer 1202 or in the software 1240 and the hardware 1234 of the UE 1214, or both. In some embodiments, sensors (not shown) may be deployed in or in association with communication devices through which the OTT connection 1216 passes; the sensors may participate in the measurement procedure by supplying values of the monitored quantities exemplified above, or supplying values of other physical quantities from which the software 1210, 1240 may compute or estimate the monitored quantities. The reconfiguring of the OTT connection 1216 may include message format, retransmission settings, preferred routing, etc.; the reconfiguring need not affect the base station 1218, and it may be unknown or imperceptible to the base station 1218. Such procedures and functionalities may be known and practiced in the art. In certain embodiments, measurements may involve proprietary UE signaling facilitating the host computer's 1202 measurements of throughput, propagation times, latency, and the like. The measurements may be implemented in that the software 1210 and 1240 causes messages to be transmitted, in particular empty or ‘dummy’ messages, using the OTT connection 1216 while it monitors propagation times, errors, etc.

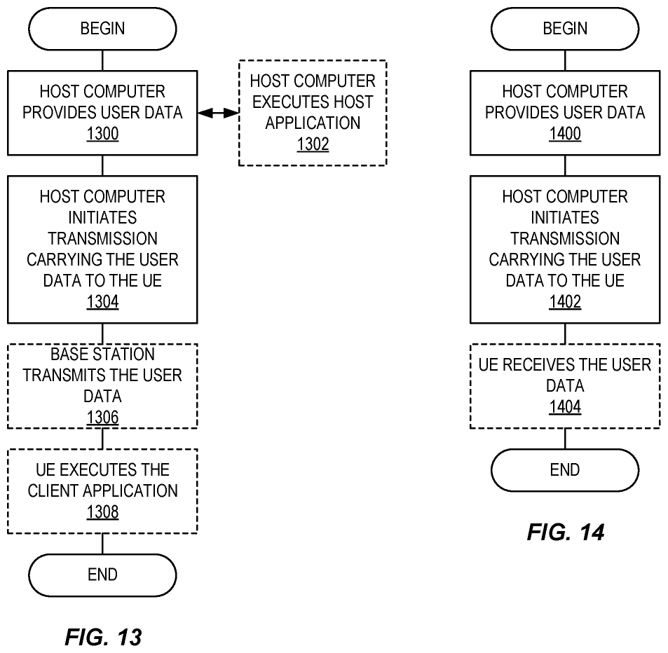

FIG. 13 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 13 will be included in this section. In step 1300, the host computer provides user data. In sub-step 1302 (which may be optional) of step 1300, the host computer provides the user data by executing a host application. In step 1304, the host computer initiates a transmission carrying the user data to the UE. In step 1306 (which may be optional), the base station transmits to the UE the user data which was carried in the transmission that the host computer initiated, in accordance with the teachings of the embodiments described throughout this disclosure. In step 1308 (which may also be optional), the UE executes a client application associated with the host application executed by the host computer.

FIG. 14 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 14 will be included in this section. In step 1400 of the method, the host computer provides user data. In an optional sub-step (not shown) the host computer provides the user data by executing a host application. In step 1402, the host computer initiates a transmission carrying the user data to the UE. The transmission may pass via the base station, in accordance with the teachings of the embodiments described throughout this disclosure. In step 1404 (which may be optional), the UE receives the user data carried in the transmission.

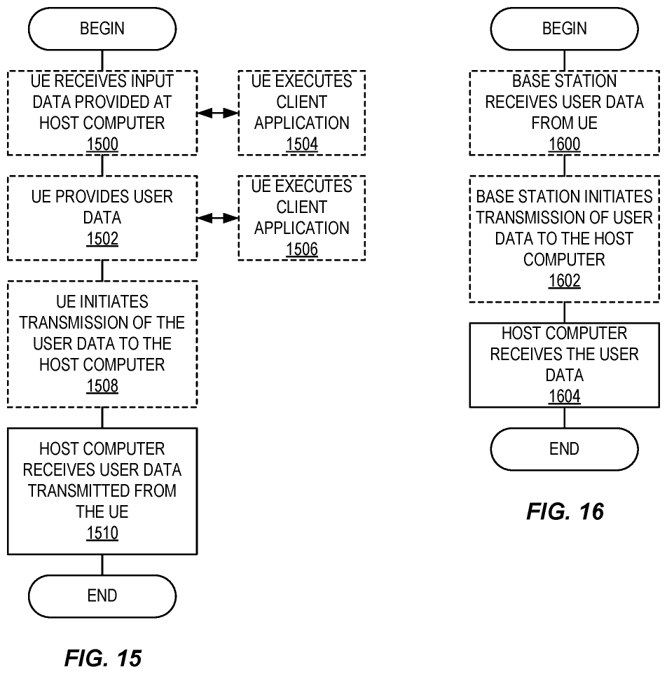

FIG. 15 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 15 will be included in this section. In step 1500 (which may be optional), the UE receives input data provided by the host computer. Additionally or alternatively, in step 1502, the UE provides user data. In sub-step 1504 (which may be optional) of step 1500, the UE provides the user data by executing a client application. In sub-step 1506 (which may be optional) of step 1502, the UE executes a client application which provides the user data in reaction to the received input data provided by the host computer. In providing the user data, the executed client application may further consider user input received from the user. Regardless of the specific manner in which the user data was provided, the UE initiates, in sub-step 1508 (which may be optional), transmission of the user data to the host computer. In step 1510 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 16 will be included in this section. In step 1600 (which may be optional), in accordance with the teachings of the embodiments described throughout this disclosure, the base station receives user data from the UE. In step 1602 (which may be optional), the base station initiates transmission of the received user data to the host computer. In step 1604 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless communication device, WCD, the method comprising:
receiving, from a base station, information that configures one or more parameters for an uplink configured grant;
determining physical uplink shared channel, PUSCH, resources for transmission of a multiple slot transport block, TB, using the uplink configured grant, based on the one or more parameters; and
transmitting the multiple slot TB on the determined PUSCH resources.

2. The method of claim 1 wherein a maximum number of repetitions for the multiple slot TB is preconfigured or predefined.

3. The method of claim 2 wherein the maximum number of repetitions for the multiple slot TB depends on a number of slots used for the multiple slot TB.

4. The method of claim 2 wherein a single maximum value of N*K is predetermined, wherein K is a number of repetitions of the multiple slot TB and N is a number of slots N for a repetition of the multiple slot TB.

5. The method of claim 1 wherein a redundancy version, RV, granularity for the multiple slot TB is a transmission occasion, wherein a transmission occasion is: (a) all slots of the multiple slot TB, (b) a subset of all slots of the multiple slot TB, or (c) a single slot of the multiple slot TB.

6. The method of claim 1 wherein transmitting the multiple slot TB comprises transmitting a number, K, of repetitions of the multiple slot TB, and a redundancy version, RV, granularity for the multiple slot TB is all slots of a repetition of the multiple slot TB.

7. The method of claim 1 wherein transmitting the multiple slot TB comprises transmitting number, K, of repetitions of the multiple slot TB, and a redundancy version, RV, granularity for the multiple slot TB is: (a) a subset of all slots of a repetition of the multiple slot T or (b) a single slot of a repetition of the multiple slot TB.

8. The method of claim 5 wherein a predetermined or indicated RV applies to a first transmission occasion of the multiple slot TB or a first transmission occasion of a first repetition of the multiple slot TB.

9. The method of claim 5 wherein the RV is cycled across transmission occasions according to a predefined or configured RV cycling pattern.

10. The method of claim 1 further comprising:
determining that at least one slot of the multiple slot TB is unavailable; and
responsive to determining that at least one slot of the multiple slot TB is unavailable,
dropping transmission of only the unavailable slot of the multiple slot TB.

11. The method of claim 1 further comprising:
determining that at least one slot of the multiple slot TB is unavailable; and
responsive to determining that at least one slot of the multiple slot TB is unavailable, either:
dropping transmission of all slots of the multiple slot TB;
dropping transmission of the unavailable slot and all subsequent slots of the multiple slot TB; or
dropping transmission of a subset of all slots of the multiple slot TB, where the subset corresponds to a transmission occasion that comprises the unavailable slot.

12. The method of claim 1 wherein transmitting the multiple slot TB comprises transmitting a number, K, of repetitions of the multiple slot TB, and the method further comprises:
determining that at least one slot of a repetition of the multiple slot TB is unavailable; and
responsive to determining that at least one slot of the multiple slot TB is unavailable:
dropping transmission of only the unavailable slot in the repetition of the multiple slot TB.

13. The method of claim 1 wherein transmitting the multiple slot TB comprises transmitting a number, K, of repetitions of the multiple slot TB, and the method further comprises:
determining that at least one slot of a repetition of the multiple slot TB is unavailable; and
responsive to determining that at least one slot of the multiple slot TB is unavailable, either:
dropping transmission of all slots in the repetition of the multiple slot TB; or
dropping transmission of the unavailable slot and all subsequent slots in the repetition of the multiple slot TB.

14. The method of claim 1 wherein the WCD is not expected to have an unavailable slot for transmission of a first repetition of the multiple slot TB.

15. The method of claim 1 wherein the multiple slot TB is a multiple slot TB with configured grant, and determining the PUSCH resources for transmission of the multiple slot TB comprises determining a starting symbol, S, within a slot of the multiple slot TB.

16. The method of claim 15 wherein the starting symbol, S, is a common starting symbol, S, value for at least a subset of the slots of the multiple slot TB.

17-19. (canceled)

20. The method of claim 1 wherein a duration of the multiple slot TB or a duration of all repetitions of the multiple slot TB is less than a time duration that corresponds to a periodicity of the uplink configured grant.

21-28. (canceled)

29. The method of claim 1 wherein the PUSCH resources are determined such that the WCD transmits K repetitions of each of N segments of the multiple slot TB.

30. The method of claim 29 wherein redundancy version is cycled across transmission occasions or cycled across segments of the multiple slot TB.

31. (canceled)

32. (canceled)

33. A wireless communication device, WCD, comprising:
one or more transmitters;
one or more receivers; and
processing circuitry associated with the one or more transmitters and the one or more receivers, the processing circuitry configured to cause the WCD to:
receive, from a base station, information that configures one or more parameters for an uplink configured grant;
determine physical uplink shared channel, PUSCH, resources for transmission of a multiple slot transport block, TB, using the uplink configured grant, based on the one or more parameters; and
transmit the multiple slot TB on the determined PUSCH resources.

34. (canceled)

35. A method performed by a wireless communication device, WCD, the method comprising:
determining physical uplink shared channel, PUSCH, resources for transmission of a multiple slot transport block;
determining that at least one slot of the multiple slot TB is unavailable; and
responsive to determining that at least one slot of the multiple slot TB is unavailable, dropping transmission of only the unavailable slot of the multiple slot TB; and
transmitting the multiple slot TB on the determined PUSCH resources.

36. The method of claim 35, wherein
transmitting the multiple slot TB comprises transmitting a number, K, of repetitions of the multiple slot TB, and
dropping transmission of only the unavailable slot of the multiple slot TB further comprises dropping transmission of only the unavailable slot in the repetition of the multiple slot TB.

37. The method of claim 36 wherein a redundancy version, RV, granularity for the multiple slot TB is all slots of a repetition of the multiple slot TB.

38. A method performed by a network node (e.g., a base station or network node that performs at least some of the functionality of the base station, the method comprising:
sending, to a wireless communication device, WCD, information that configures one or more parameters for an uplink configured grant; and
transmitting a multiple slot transport block, TB, from the WCD on physical uplink shared channel, PUSCH, resources in accordance with the uplink configured grant.

39-57. (canceled)

58. A network node comprising processing circuitry configured to cause the network node to:
send, to a wireless communication device, WCD, information that configures one or more parameters for an uplink configured grant; and
transmit a multiple slot transport block, TB, from the WCD on physical uplink shared channel, PUSCH, resources in accordance with the uplink configured grant.

59. (canceled)
